(19) United States
(12) Patent Application Publication
(10) Pub. No.: US 2008/0091841 A1
(43) Pub. Date: Apr. 17, 2008

(54) Communication method, communication system, communication apparatus, and recording medium

(75) Inventors: Satoshi Namura, Osaka (JP); Hideki Kawada, Osaka (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki-shi (JP)

(21) Appl. No.: 11/902,941

(22) Filed: Sep. 26, 2007

(30) Foreign Application Priority Data
Oct. 13, 2006 (JP) 2006-280559

(51) Int. Cl. G06F 15/16

(52) U.S. Cl. 709/237

(57) ABSTRACT

A communication method is provided in which irrespective of whether the communication apparatus is in a condition of being able to cache the received data or not, it is made possible to receive segment data having a sequence number assigned thereto continuously with the reception of the resent lost data, whereby the reduction in communication throughput can be reduced and the time can be reduced that is required for the reception of all the segment data to be completed. In a first communication apparatus and a second communication apparatus that perform data communication based on the TCP, the first communication apparatus receives information corresponding to a scheduled sequence number equal to the previously received scheduled sequence number (S205: YES), and when the number of times of continuous reception reaches a predetermined number of times (S208: YES), returns the sequence number to the received scheduled sequence number (S209).

### CROSS-REFERENCE OF RELATED APPLICATION

This non-provisional application claims priority under 35 U.S.C. §119(a) on Patent Application No. 2006-280559 in Japan on Oct. 13, 2006, the entire contents of which are hereby incorporated by reference.

### BACKGROUND

1. Technical Field

The present invention relates to data communication between communication apparatuses based on the TCP (Transmission Control Protocol), and more particularly, relates to a communication method by which lost data can be smoothly resent.

2. Description of Related Art

Conventionally, problems such as data corruption, packet losses, overlaps, and transposition occur in communication between communication apparatuses. Therefore, the OSI reference model which is a standard for communication between communication apparatuses ensures the reliability of communication by causing each communication apparatus to perform check sum, sequence control in accordance with requests, acknowledgement, resending control, connection management, window control, and the like based on the TCP.

A conventional communication method based on the TCP is described in, for example, TCP/IP Illustrated Vol. 1, W. Richard Stevens, Addison-Wesley Publishing Company, 1994, Ch. 18, pp. 252-255 and Ch. 21, pp. 306-312; TCP/IP Illustrated Vol. 2, Gary R. Wright and W. Richard Stevens, Addison-Wesley Publishing Company, 1995, Ch. 29, pp. 971-974; Japanese Patent No. 3315926; and Japanese Patent Application Laid-Open No. H11-341072. According to the TCP, when a communication apparatus A on the data transmission side transmits data, a communication apparatus B on the data reception side returns an acknowledgement (hereinafter, referred to as “ACK”) of the reception. Consequently, the communication apparatus A receiving the ACK can confirm the arrival of the data.

Moreover, according to the TCP, when a massive amount of data is communicated between communication apparatuses, the maximum data unit that can be communicated is determined. The determined data is called the maximum segment size (hereinafter, referred to as “MSS”), and when a large amount of data is transmitted, the data is divided into pieces of data of the MSS (called segment data).

### SUMMARY

According to the communication method based on the conventional TCP, as a general rule, when transmitting segment data, the communication apparatus A transmits the next segment data after receiving the ACK returned from the communication apparatus B. The communication apparatus B alternately performs the reception of the segment data and the transmission of the ACK until completing the reception of all the segment data.

To increase the speed of data communication, the conventional TCP provides the maximum number of segments (called window size) that can be transmitted without the communication apparatus A waiting for the arrival of the ACK from the communication apparatus B. A communication method is made standard by which the speed of data communication can be increased by the communication apparatus A continuously transmitting a plurality of pieces of segment data to thereby reduce the time required for the communication apparatus B to complete the reception of all the segment data. FIG. 1 is an explanatory view showing a communication sequence controlled by the conventional method.

According to the communication method, for example, the following control based on the TCP is performed: The communication apparatus A previously receives the receivable window size from the communication apparatus B. The communication apparatus A transmits segment data having a sequence number (n) assigned thereto, and updates the sequence number (n) to n+m (segment 1). Further, the communication apparatus A successively transmits segment data without waiting for the ACK to be transmitted from the communication apparatus B (segments 2, 3, and 4).

When receiving the data of the segment 1, the communication apparatus B transmits the received data of the segment 1 to an application processor, generates a scheduled sequence number (n+m) representing the sequence number of the data to be received next based on the sequence number (n) of the received data of the segment 1, and transmits an ACK including the generated scheduled sequence number (n+m) to the communication apparatus A (segment 5).

There are cases where some pieces of the segment data are lost and do not reach the communication apparatus B while the communication apparatus A is successively transmitting the segment data. In these cases, the communication apparatus B does not receive the data of the segment 2, does not update the scheduled sequence number based on the sequence number assigned to the data, and does not transmit the data to the application processor.

Therefore, the communication apparatus B transmits an ACK including the previously received scheduled sequence number (n+m) to the communication apparatus A (segment 8). Thereafter, until receiving segment data having an equal sequence number (n+m) to that of the lost data of the segment 2 assigned thereto, the communication apparatus B successively caches the data of the segments 3, 4, 6, 7, 9, and 11 received from the communication apparatus A in memory, and successively transmits an ACK including the scheduled sequence number (n+m) to the communication apparatus A (segments 8, 10, 12, 14, 16, and 18).

When continuously receiving the ACK including an equal scheduled sequence number (n+m) (segments 8, 10, and 12) a predetermined number of times (normally, three times) after receiving the ACK including the scheduled sequence number (n+m) of the segment 5, the communication apparatus A transmits segment data having an equal sequence number to the scheduled sequence number (n+m) assigned thereto (segment 13). When receiving the data of the segment 13, the communication apparatus B successively reads the data of the segments 3, 4, 6, 7, 9, and 11 successively cached in memory, transmits the read data to the application processor, and transmits the received data of the segment 13 to the application processor (for example, the non-patent document 1, the non-patent document 2, the patent document 1, and the patent document 2).

In this manner, the reliability of data communication between the communication apparatuses A and B is ensured.

However, the communication method according to the conventional TCP causes the following problem because there are cases where the data successively received from the communication apparatus A are discarded without cached in memory, for example, when mass-storage cache memory cannot be used in the communication apparatus B from the viewpoint of the reduction of the installation space or the cost. FIGS. 2 and 3 are explanatory views showing a communication sequence controlled by the conventional method.

Explaining with the example described above, since the communication apparatus B cannot cache the received data of the segments 3, 4, 6, 7, 9, and 11 in memory and discards it until segment data of an equal sequence number (n+m) to that of the lost data of the segment 2 is received, the communication apparatus B transmits only the data of the segment data 13 to the application processor when receiving the data of the segment 13. This makes it necessary for the communication apparatus B to request the communication apparatus A to resend the discarded data of the segments 3, 4, 6, 7, 9, and 11.

The communication apparatus B generates a scheduled sequence number (n+2m) based on the sequence number (n+m) of the data of the segment 13, and successively transmits an ACK including the generated scheduled sequence number (n+2m) to the communication apparatus A (segments 20, 22, 24, 26, 28, 30, and 32).

When continuously receiving an ACK including an equal scheduled sequence number (n+2m) a plurality of times after receiving the ACK including the scheduled sequence number (n+2m) of the segment 20, the communication apparatus A resends the segment data having the sequence number (n+2m) assigned thereto (segment 27). At this time, since the communication apparatus B has discarded the data of the segments 15, 17, 19, 21, 23, and 25 received before the data of the segment 3 is resent, the necessity for requesting the communication apparatus A to resend the discarded segment data further arises.

As described above, according to the communication methods based on the conventional TCP, when the communication apparatus B is in a condition of being unable to cache the received data, the resending of the lost data by the communication apparatus A becomes a trigger, and the interval at which the communication apparatus B transmits the successively received segment data to the application processor becomes several segments, so that the throughput between the communication apparatuses is significantly reduced and consequently, it takes a long time for the communication apparatus B to finish the transmission of all the segment data to the application processor.

Accordingly, an object is to provide a communication method in which, of a plurality of communication apparatuses that perform one-way or two-way data communication based on the TCP, a first communication apparatus transmits data to a second communication apparatus and the second communication apparatus successively transmits the resent segment data to the application processor irrespective of whether the second communication apparatus is in a condition of being able to cache the received data or not, whereby the reduction in communication throughput can be avoided and the time can be reduced that is required for the reception of all the segment data to be completed.

Another object is to provide a communication method in which a first communication apparatus is made not to unnecessarily resend data to suppress the number of pieces of segment data received by a second communication apparatus and suppress the number of pieces of segment data transmitted by the first communication apparatus, whereby the reduction in communication throughput can be avoided and the time can be reduced that is required for the reception of all the segment data to be completed.

Yet another object is to provide a communication method that can be made not to be used when a second communication apparatus is capable of only communication based on the conventional TCP.

There is provided a communication method according to one aspect for performing data communication between a first apparatus for communication and a second apparatus for communication based on a TCP, comprising: successively transmitting data having a sequence number assigned thereto from the first apparatus to the second apparatus; updating the sequence number by the first apparatus every transmission; receiving the data transmitted from the first apparatus, by the second apparatus; generating information corresponding to a scheduled sequence number representing a sequence number of data to be received next, by the second apparatus every reception; transmitting the generated information corresponding to the scheduled sequence number from the second apparatus to the first apparatus; and when continuously receiving information corresponding to an equal scheduled sequence number a plurality of times by the first apparatus, successively transmitting data corresponding to the equal scheduled sequence number and a succeeding sequence number from the first apparatus to the second apparatus.

There is provided the communication method according to one aspect, wherein the equal scheduled sequence number precedes the updated sequence number.

There is provided the communication method according to one aspect, further comprising: transmitting a start acknowledgement as to start of data communication from the first apparatus to the second apparatus; transmitting a start response to the received start acknowledgement from the second apparatus to the first apparatus; and when receiving the start response by the first apparatus, transmitting the data from the first apparatus to the second apparatus.

There is provided a communication method according to one aspect for alternately transmitting one or a plurality of pieces of data between a first apparatus for communication and a second apparatus for communication based on a TCP, comprising: successively transmitting data having a sequence number assigned thereto from the first apparatus to the second apparatus; updating the sequence number by the first apparatus every transmission; when receiving the data transmitted from the first apparatus to the second apparatus, by the second apparatus subsequently to data transmission from the second apparatus to the first apparatus, generating by the second apparatus a variable representing the reception and information corresponding to a scheduled sequence number representing a sequence number of data to be received next; transmitting the generated variable and information corresponding to the scheduled sequence number from the second apparatus to the first apparatus; and when continuously receiving information corresponding to an equal scheduled sequence number together with the variable a plurality of times by the first apparatus, successively transmitting data corresponding to the equal scheduled sequence number and a succeeding sequence number from the first apparatus to the second apparatus.

There is provided a communication system according to one aspect provided with a first apparatus for communication and a second apparatus for communication and performing data communication between the apparatuses based on a TCP, wherein the first apparatus comprises: an interface that successively transmits data having a sequence number assigned thereto; and a processor that updates the sequence number every transmission, wherein the second apparatus comprises: an interface that receives the data transmitted from the first apparatus; and a processor that generates information corresponding to a scheduled sequence number representing a sequence number of data to be received next every reception, wherein the interface of the second apparatus transmits the generated information corresponding to the scheduled sequence number, wherein the interface of the first apparatus receives the information corresponding to the scheduled sequence number transmitted from the second apparatus, wherein the processor of the first apparatus determines whether the received scheduled sequence number is equal to a previously received scheduled sequence number or not, wherein the first apparatus further comprises a counter that counts, when the processor of the first apparatus determines that the received scheduled sequence number is equal, a number of times the information corresponding to the received scheduled sequence number is continuously received, wherein the processor of the first apparatus determines whether a predetermined number of times is reached as a result of the counting or not, and wherein when the processor of the first apparatus determines that the predetermined number of times is reached, the interface of the first apparatus successively transmits data corresponding to the received scheduled sequence number and a succeeding sequence number to the second apparatus.

There is provided the communication system according to one aspect, wherein the processor of the first apparatus determines whether the received scheduled sequence number precedes the updated sequence number or not, and only when a result of the determination is affirmative, determines whether the received scheduled sequence number is equal to the previously received scheduled sequence number or not.

There is provided the communication system according to one aspect, wherein the interface of the first apparatus transmits a start acknowledgement as to start of data communication, wherein the interface of the second apparatus transmits a start response to the received start acknowledgement, and wherein the interface of the first apparatus transmits the data when receiving the start response.

There is provided a communication apparatus according to one aspect capable of data communication with an outside based on a TCP, comprising: an interface that successively transmits data having a sequence number assigned thereto; and a processor that updates the sequence number every transmission, wherein the interface receives information corresponding to a scheduled sequence number transmitted from an external apparatus, wherein the processor determines whether the received scheduled sequence number precedes the updated sequence number or not, and when a result of the determination is affirmative, determines whether the received scheduled sequence number is equal to the previously received scheduled sequence number or not, wherein the communication apparatus further comprises a counter that counts, when the processor determines that the received scheduled sequence number is equal, a number of times the information corresponding to the received scheduled sequence number is continuously received, and wherein when a predetermined number of times is reached as a result of the counting, the interface successively transmits data corresponding to the received scheduled sequence number and a succeeding sequence number to the external apparatus.

There is provided a computer-readable storage medium according to one aspect storing a computer-executable computer program for causing a computer to perform data communication with an outside based on a TCP, the computer program comprising: causing the computer to update a sequence number assigned to data every time the data is transmitted; causing the computer to determine whether a scheduled sequence number received from the external apparatus precedes the updated sequence number or not, causing the computer to determine whether the received scheduled sequence number is equal to a previously received scheduled sequence number or not when a result of the determination is affirmative, causing the computer to count a number of times information corresponding to the received scheduled sequence number is continuously received when the computer determines that the received scheduled sequence number is equal, and causing the computer to successively transmit data corresponding to the received scheduled sequence number and a succeeding sequence number when a predetermined number of times is reached as a result of the counting.

According to one aspect, since the first communication apparatus successively transmits, when continuously receiving information corresponding to an equal scheduled sequence number a plurality of times, data of the scheduled sequence number and a succeeding sequence number, the second communication apparatus can successively receive the lost segment data and segment data of a succeeding sequence number and transmit them to the application processor even when it is in a condition of being unable to cache segment data. Consequently, the successively received segment data can be successively sent to the application processor without any interval of several segments between the transmissions, so that the reduction in the throughput between the communication apparatuses can be avoided and the second communication apparatus can reduce the time required for the reception of all the segment data to be completed.

Moreover, according to one aspect, since the first communication apparatus successively transmits, when successively receiving information corresponding to an equal scheduled sequence number not more than the sequence number that has been updated from the second communication apparatus a plurality of times, data of the scheduled sequence number and a succeeding sequence number, for example, data can be made not to be unnecessarily resent when the scheduled sequence number is higher than the sequence number updated in the past, that is, until information corresponding to a scheduled sequence number not based on the sequence number of the lost data transmitted in the past is received a plurality of times.

Moreover, according to one aspect, when information corresponding to an equal scheduled sequence number not more than the sequence number that has been updated is continuously received a plurality of times together with a variable representing reception, data of the scheduled sequence number and a succeeding sequence number is successively transmitted. Between two-way communications in which data is alternately transmitted, since the second communication apparatus transmits data of a segment length 0 or longer even when receiving no data from the first communication apparatus, the first communication apparatus cannot determine whether the information corresponding to the scheduled sequence number received together with data is a scheduled sequence number based on the loss of segment data or a scheduled sequence number not based on the loss of segment data, and cannot decide to trigger the counting of an equal scheduled sequence number. However, by using the variable of the present invention, the first communication apparatus can determine whether the information corresponding to the scheduled sequence number received together with data is based on the loss of segment data or not and decide to trigger the counting of an equal scheduled sequence number.

Further, according to one aspect, by the first communication apparatus transmitting data when the second communication apparatus responds to a start acknowledgement, when the second communication apparatus compliant with only communication methods based on the conventional TCP receives data, a communication method based on the conventional TCP is used to thereby avoid a situation in which communication with the second communication apparatus is impossible.

According to one aspect, the second communication apparatus can successively receive the lost segment data and segment data of a succeeding sequence number and transmit them to the application processor even when it is in a condition of being unable to cache the segment data, and without any interval of several segments between the transmissions of the segment data to the application processor, the reduction in the throughput between the communication apparatuses can be avoided, and the second communication apparatus can reduce the time required for the reception of all the segment data to be completed.

Moreover, according to one aspect, for example, data can be made not to be unnecessarily resent when the scheduled sequence number is higher than the sequence number updated in the past, that is, until information corresponding to a scheduled sequence number not based on the sequence number of the lost data transmitted in the past is received a plurality of times, the number of pieces of segment data received by the second apparatus can be suppressed, and the number of pieces of segment data transmitted by the first communication apparatus can be suppressed, so that the reduction in communication throughput can be avoided and the time required for the reception of all the segment data to be completed can be reduced.

Moreover, according to one aspect, between two-way communications in which data is alternately transmitted, the first communication apparatus can determine whether the information corresponding to the received scheduled sequence number is based on the loss of segment data or not, and can decide to trigger the counting of an equal scheduled sequence number.

Moreover, according to one aspect, even when data is transmitted to the second communication apparatus compliant with only communication methods based on the conventional TCP, a situation in which communication between the apparatuses is impossible can be avoided.

### BRIEF DESCRIPTION OF THE SEVERAL VIEWS OF THE DRAWINGS

FIG. 1 is an explanatory view showing the communication sequence controlled by the conventional method;

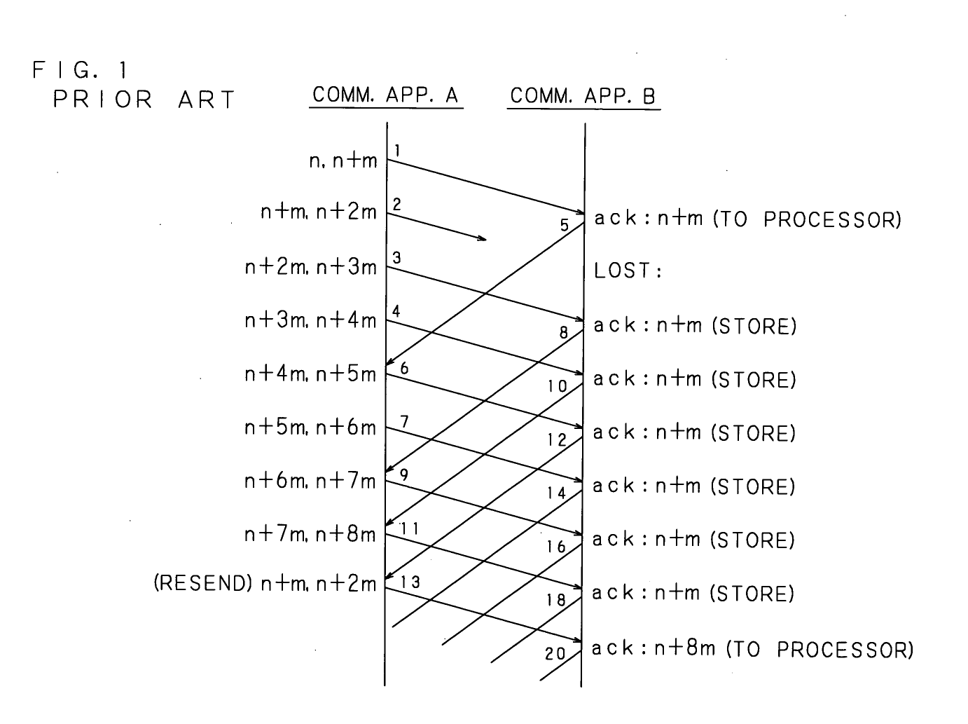

FIG. 2 is an explanatory view showing the communication sequence controlled by the conventional method;

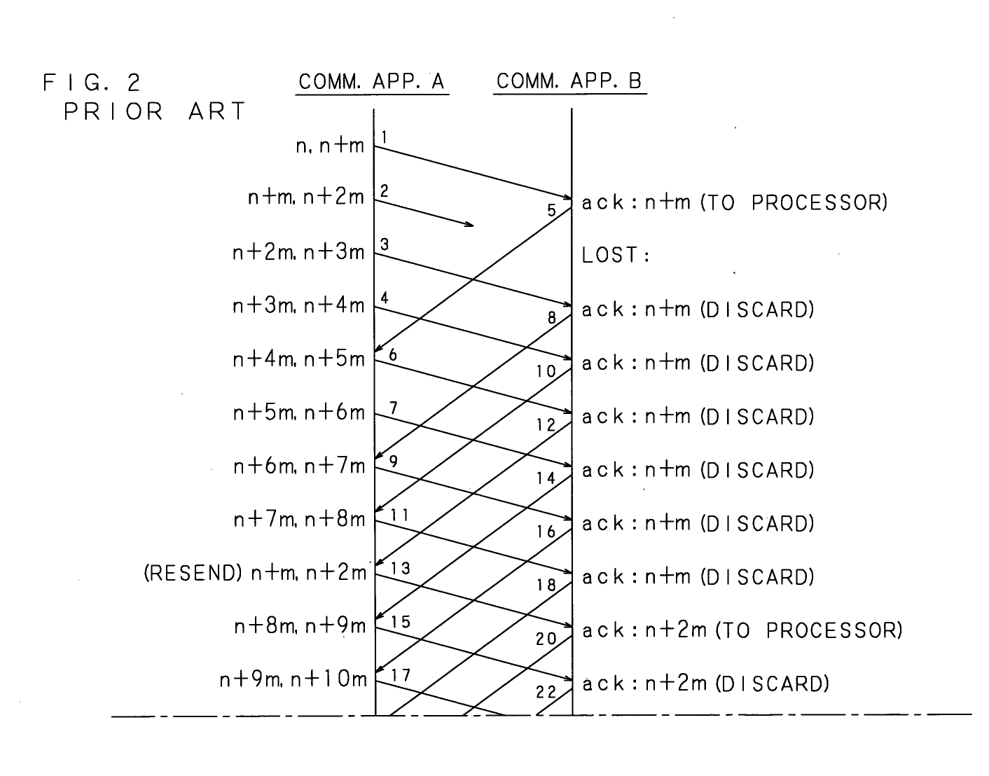

FIG. 3 is an explanatory view showing the communication sequence controlled by the conventional method;

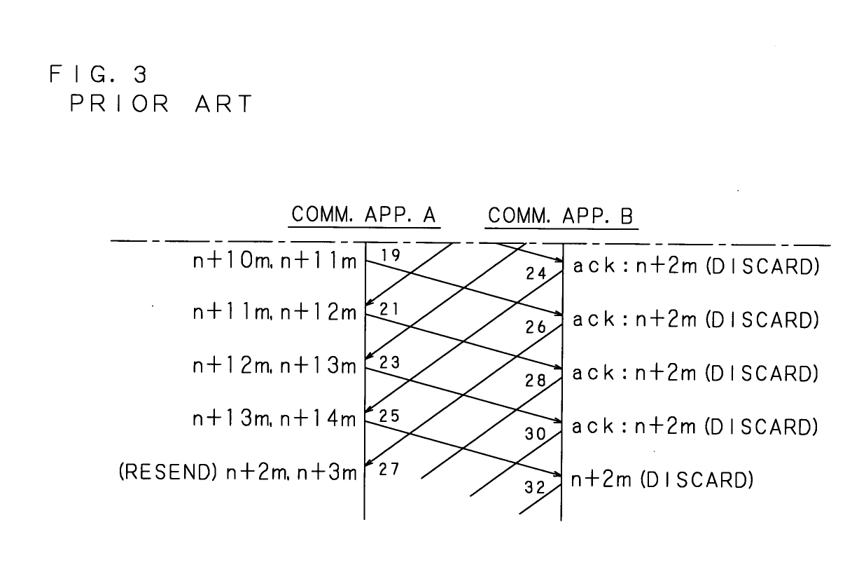

FIG. 4 is a block diagram for explaining the general structure of a communication system according to embodiments;

FIG. 5 is a schematic view showing the contents of a TCP header used in the embodiments;

FIG. 6 is an explanatory view showing an example of the communication sequence controlled in an embodiment;

FIG. 7 is an explanatory view showing an example of the communication sequence controlled in an embodiment;

FIG. 8 is an explanatory view showing an example of the communication sequence controlled in an embodiment;

FIG. 9 is an explanatory view showing an example of the communication sequence controlled in an embodiment;

FIG. 10 is an explanatory view showing an example of the communication sequence controlled in an embodiment;

FIG. 11 is an explanatory view showing an example of the communication sequence controlled in an embodiment;

FIG. 12 is an explanatory view showing an example of the communication sequence controlled in an embodiment;

FIG. 13 is an explanatory view showing an example of the communication sequence controlled in an embodiment;

FIGS. 14A to 14C are explanatory views showing sequence numbers and scheduled sequence numbers;

FIG. 15 is a flowchart explaining the procedure of the transmission processing of a first communication apparatus; and

FIG. 16 is a flowchart explaining the procedure of the reception processing of the first communication apparatus.

### DETAILED DESCRIPTION

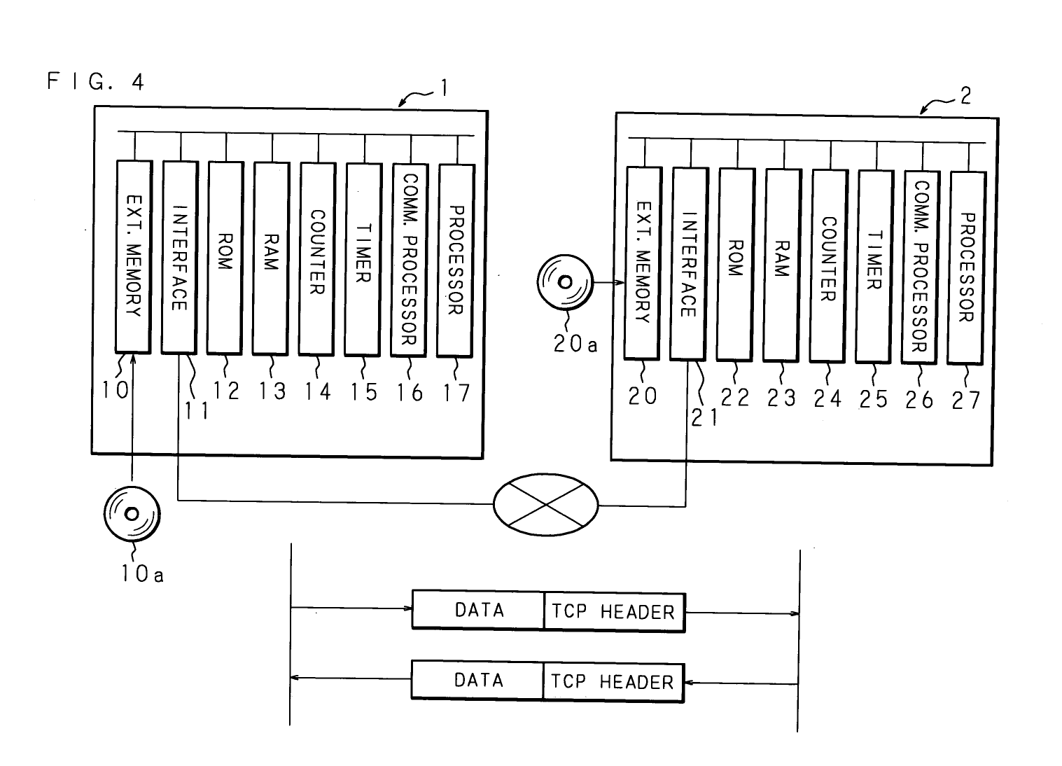

Hereinafter, a communication method according to embodiments will be described based on the drawings. FIG. 4 is a block diagram for explaining the general structure of a communication system according to the embodiments.

In FIG. 4, reference numeral 1 represents a first communication apparatus the data communication by which is controlled based on the TCP. The first communication apparatus 1 includes an external storage device 10, a communication interface 11, a ROM 12, a RAM 13, a counter 14, a timer 15, a communication processor 16, and an application processor 17.

The external storage device 10 reads information from a portable recording medium 10a such as a CD-ROM storing information such as various programs such as a computer program for causing the first communication apparatus 1 to execute the communication method according to the embodiments, and data, and transmits the read information to the ROM 12 or the RAM 13.

The communication interface 11 is an interface for connection to communication networks, and a TCP header including the window size, the sequence number, the ACK, and the like, and segment data are transmitted to or received from another communication apparatus through the connected communication network.

The ROM 12 stores various programs such as the computer program that causes the communication method according to the embodiments to be executed and data related to the communication protocol such as the TCP which are read and transmitted to the RAM 13 as required.

The RAM 13 is constituted by an SRAM, a flash memory, or the like, and stores externally received segment data, TCP header and the like which are transmitted to the communication processor 16 or the application processor 17 as required.

The counter 14 counts the number of times of continuous reception of a TCP header including a scheduled sequence number, or the like. For example, the counter 14 starts the counting when determining that the received scheduled sequence number is equal to the previously received scheduled sequence number, and transmits a count reached signal to the communication processor 16 when a predetermined number of times is reached.

The timer 15 counts the interval between the time-out processing controlled by the TCP and the transmission segment and the interval between the transmission and reception segments in two-way communication, and transmits the counting reached signal when a predetermined time is reached.

The communication processor 16 stores the window size information included in the received TCP header into the RAM 13 based on the computer program that causes the communication method according to the embodiments to be executed, the data related to the communication protocol such as the TCP, and the like, and successively transmits segment data within the range of the stored window size. Moreover, the communication processor 16 updates a flag such as the sequence number or the ACK included in the TCP header. Moreover, when determining that the received TCP includes an equal sequence number, the communication processor 16 causes the counter 14 to count the number of times of continuous reception, accepts the count reached signal from the counter 14, and successively transmits sequence data of the scheduled sequence number and a succeeding sequence number.

Moreover, the communication processor 16 determines whether or not the segment data to be externally received is received in response to the transmission of the segment data based on the TCP, and when determining that the segment data is received, further determines whether or not the sequence number included in the received TCP is equal to the scheduled sequence number stored in the RAM 13. When determining that the sequence number is equal, the communication processor 16 generates a scheduled sequence number based on the sequence number of the received TCP header, and transmits a TCP header including the generated scheduled sequence number, an ACK flag ‘1’, and a CAK (counter ACK) flag ‘1’.

The application processor 17 performs the communication processing based on the protocol included in the application layer higher than the transport layer to which the TCP belongs. For example, file transfer, electronic mail, and remote login (used for realizing virtual terminals and the like).

A second communication apparatus 2, and an external storage device 20, a portable recording medium 20a, a communication interface 21, a ROM 22, a RAM 23, a counter 24, a timer 25, a communication processor 26, and an application processor 27 provided in the second communication apparatus 2 will not be described because they correspond to the first communication apparatus 1 and the pieces of hardware provided in the first communication apparatus 1 and have the same structure and workings.

The forms of communication between the first communication apparatus 1 and the second communication apparatus 2 are “one-way communication” in which one apparatus transmits data larger than a segment length ‘0’ having a TCP header attached thereto and the other apparatus transmits data with the segment length ‘0’ having a TCP header attached thereto (that is, only the TCP header) and “two-way communication” in which both apparatuses alternately transmit data larger than the segment length ‘0’ having a TCP header attached thereto to each other.

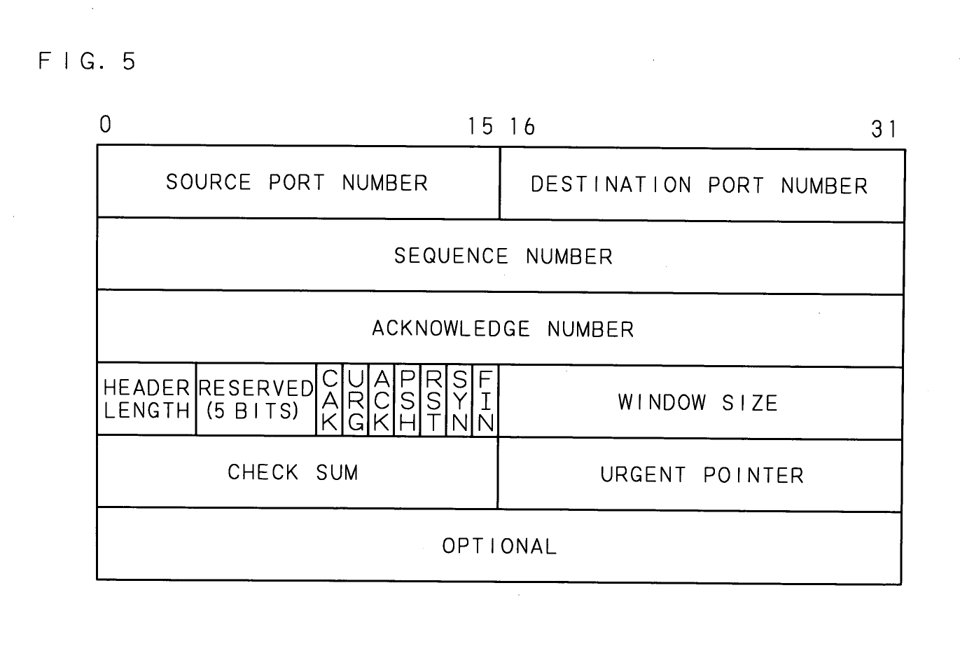

Next, the contents of the TCP header used in the embodiments will be described. FIG. 5 is a schematic view showing the contents of the TCP header used in the embodiments.

The TCP header is a 32-bit length field including the following in multiple layers: source port number; destination port number; sequence number; acknowledge number; header length; reserved; control flag; window size; check sum; urgent pointer; and optional. The TCP header is transmitted and received by communication apparatuses in a condition of being attached to segment data.

Source port number is a 16-bit length field, and represents the port number of the source.

Destination port number is a 16-bit length field, and represents the port number of the destination.

Sequence number is a 32-bit length field, and represents the position of the transmitted segment data. The initial value is determined by a random number n when communication negotiation is established between communication apparatuses, and is incremented by the amount of the transferred segment data (m bytes) every time segment data is transmitted. The initial value may be decremented.

Acknowledge number is a 32-bit length field, and is a scheduled sequence number representing the sequence number of the segment data to be received next. The acknowledge number is updated based on the sequence number of the received segment data. The updated acknowledge number is equal to the maximum value of the sequence numbers of the received segment data. When the segment data is lost and cannot be received, the acknowledge number is different from the sequence number of the received segment data.

Header length is a 4-bit length field, and represents the length of the TCP header.

Reserved is a field reserved for feature expansion in the future, and is five bits in length.

Control flag is seven bits in length, and the bits are, from the left, CAK, URG, ACK, PSH, PST, SYN, and FIN which have the following meanings when updated to ‘1’: CAK is updated to ‘1’ when data to be received is received in response to the transmission of the data in two-way communication, and is treated as a variable representing that the data is received. URG (URGENT) indicates that data to be urgently processed is included. ACK indicates the acknowledgement of the reception when data is received in one-way communication or when data to be received is received in response to the transmission of the data in two-way communication. PSH (PUSH) indicates that it is necessary to immediately transmit the received data to the application processor. When PSH is ‘0’, buffering into the RAM is permitted. RST (RESET) indicates that communication is forcibly disconnected. SYN (SYNCHRONIZE) indicates that the establishment of communication is requested. FIN indicates that disconnection of communication is requested.

Window size is a 16-bit length field, and represents the maximum number of segments that can be transmitted without the arrival of the ACK being waited for. The communication apparatuses are not allowed to communicate segment data beyond the window size.

Check sum is a 16-bit length field, and guarantees that the RAM of the communication apparatus is not broken or the segment data is not corrupted due to a program bug.

Urgent pointer is a 16-bit length field, and becomes valid when the above-described URG is ‘1’. The value shown in this field is used as the pointer representing where the urgent data is stored.

Optional is a field used for improving communication based on the TCP, and used, for example, for the determination of the MSS and the resend flag representing whether the data communication is normal communication or resending communication.

### First Embodiment

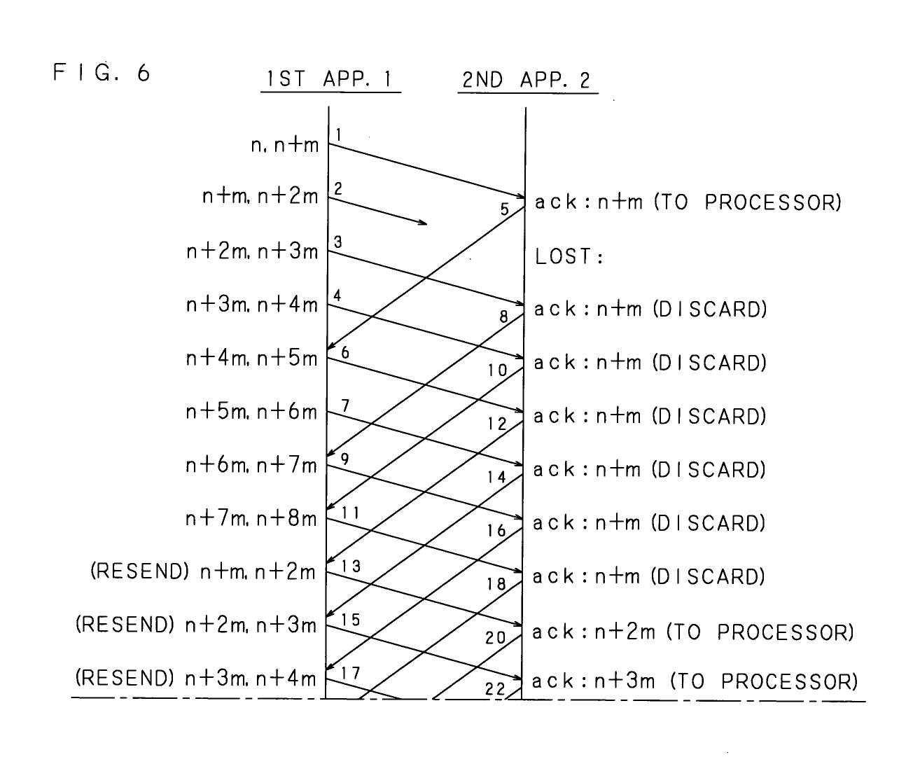

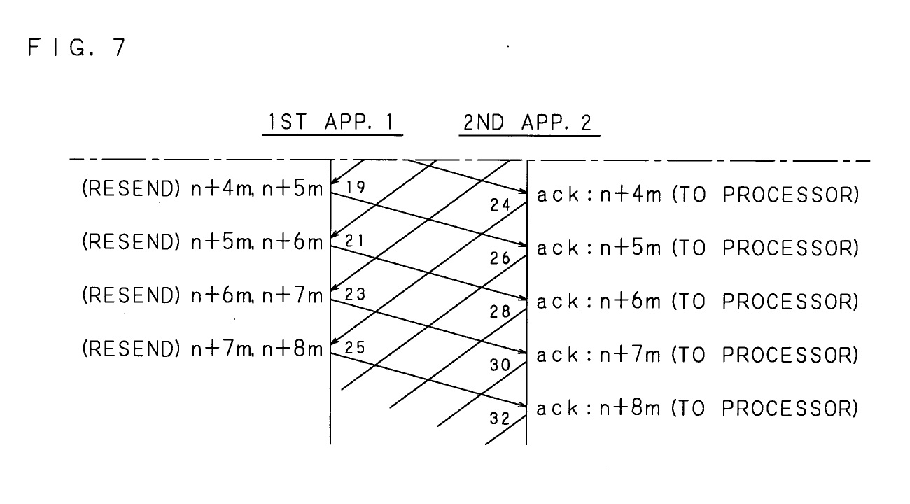

Next, the procedure of the communication controlled in an embodiment will be described. FIGS. 6 and 7 are explanatory views showing an example of the communication sequence controlled in the embodiment. Hereinafter, a case where the communication form is “one-way communication” and the second communication apparatus 2 cannot store the successively received segment data into the RAM 23 and discards it will be described as an example.

First, the first communication apparatus 1 transmits the TCP header of an SIN flag ‘1’ to the second communication apparatus 2, and the second communication apparatus 2 transmits a TCP header including the window size (for example, the maximum number of segments: 30). The first communication apparatus 1 stores the received window size into the RAM 13. This enables data communication between the communication apparatuses with the maximum number of segments being 30, and communication of data divided into segment data of the MSS of m bytes is performed.

The first communication apparatus 1 transmits segment data having a sequence number (n) assigned thereto, and updates the sequence number (n) to n+m (segment 1). Further, the communication apparatus 1 successively transmits segment data without waiting for the arrival of the ACK to be transmitted from the communication apparatus 2 (segments 2, 3, and 4).

When receiving the data of the segment 1, the second communication apparatus 2 sends the received data of the segment 1 to the application processor 27, generates a scheduled sequence number (n+m) representing the sequence number of the data to be received next based on the sequence number (n) of the received data of the segment 1, and transmits a TCP header including the generated scheduled sequence number (n+m) and the ACK flag ‘1’ to the first communication apparatus 1 (segment 5).

When the data of the segment 2 transmitted by the first communication apparatus 1 is lost and does not arrive at the second communication apparatus 2, the second communication apparatus 2 cannot receive the data of the segment 2, cannot send the data to the application processor 27, and cannot generate information corresponding to the scheduled sequence number. Moreover, although the second communication apparatus 2 receives the data of the segment 3 transmitted from the first communication apparatus 1, it cannot send it to the application processor 27 because the sequence number of the received data of the segment 3 is not equal to the previously generated scheduled sequence number. Further, the second communication apparatus 2 discards the segment data because it is in a condition of being unable to store the segment data into the RAM 23. The second communication apparatus 2 transmits a TCP header including the previously generated scheduled segment number (n+m) and ACK ‘1’ to the first communication apparatus 1 (segment 8).

The first communication apparatus 1 successively transmits segment data having a sequence number assigned thereto (segments 4, 6, 7, 9, and 11). The second communication apparatus 2 successively transmits a TCP header including the scheduled sequence number (n+m) and a TCP header including ACK ‘1’ while discarding the received data of the segments 4, 6, 7, 9, and 11 (segments 10, 12, 14, 16, and 18).

When continuously receiving a TCP header including an equal scheduled sequence number (n+m) (segments 8, 10, and 12) three times, the first communication apparatus 1 successively transmits segment data having the scheduled sequence number (n+m) and a succeeding sequence number attached thereto (segments 13, 15, 17, 19, 21, 23, and 25).

The second communication apparatus 2 successively receives the data of the segments 13, 15, 17, 19, 21, 23, and 25 having the scheduled sequence number (n+m) and a succeeding sequence number assigned thereto, sends the segment data to the application processor 27 every reception, generates a scheduled sequence number every reception based on the sequence numbers of the data of the segments 13, 15, 17, 19, 21, 23, and 25, and successively transmits an TCP header including the generated scheduled sequence number and the ACK flag ‘1’ to the first communication apparatus 1 (segments 20, 22, 24, 26, 28, 30, and 32).

### Second Embodiment

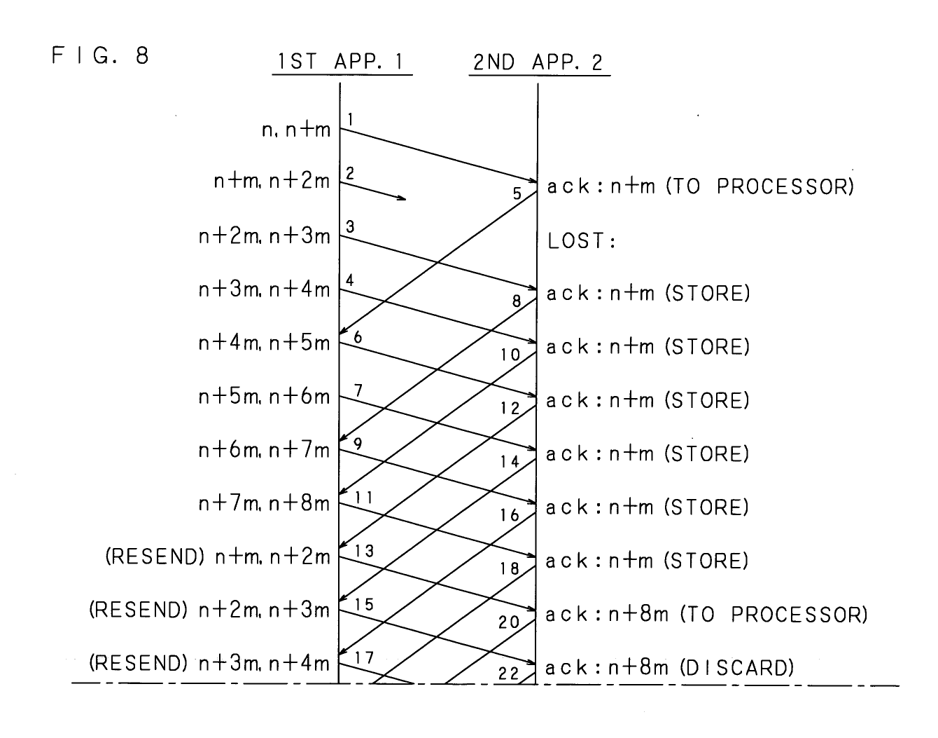

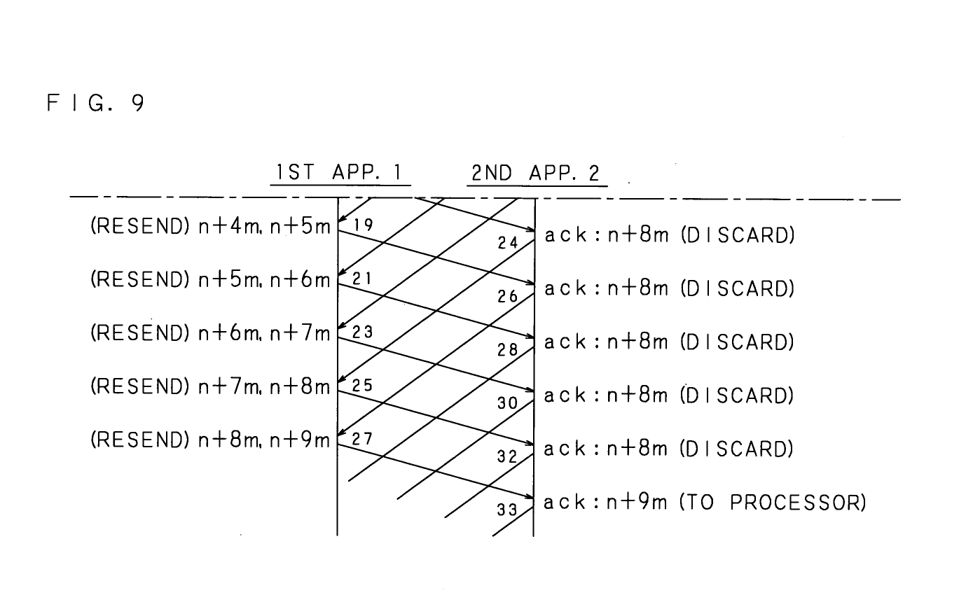

Next, a case where the communication form is “one-way communication” and the second communication apparatus 2 can store the successively received segment data into the RAM 23 will be described as an example. FIGS. 8 and 9 are explanatory views showing an example of the communication sequence controlled in an embodiment.

Like the first embodiment, the first communication apparatus 1 stores the window size into the RAM 13, transmits segment data having a sequence number (n) assigned thereto, and updates the sequence number (n) to n+m (segment 1). When receiving the received data of the segment 1, the second communication apparatus 2 sends the received segment data to the application processor 27, and transmits a TCP header including the scheduled sequence number (n+m) and the ACK flag ‘1’ to the first communication apparatus 1 (segment 5).

When the data of the segment 2 transmitted by the first communication apparatus 1 is lost and does not arrive at the second communication apparatus 2, the second communication apparatus 2 cannot receive the data of the segment 2, cannot send the data to the application processor 27, and cannot generate information corresponding to the scheduled sequence number. Moreover, although the second communication apparatus 2 receives the data of the segment 3 transmitted from the first communication apparatus 1, it cannot send it to the application processor 27 because the sequence number of the received data of the segment 3 is not equal to the previously generated scheduled sequence number. Further, the second communication apparatus 2 successively stores the received segment data into the RAM 23, and transmits a TCP header including the scheduled sequence number (n+m) to the first communication apparatus 1 (segments 8, 10, 12, 14, 16, and 18).

When continuously receiving a TCP header including an equal scheduled sequence number (n+m) (segments 8, 10, and 12) three times, the first communication apparatus 1 successively transmits segment data having the scheduled sequence number (n+m) and a succeeding sequence number assigned thereto (segments 13, 15, 17, 19, 21, 23, and 25).

When receiving the data of the segment 13 having the scheduled sequence number (n+m) assigned thereto, the second communication apparatus 2 reads the data of the segments 3, 4, 6, 7, 9, and 11 stored in the RAM 23, successively sends them to the application processor 27, and sends the data of the segment 13 to the application processor 27. Moreover, the second communication apparatus 2 generates a scheduled sequence number (n+8m) representing the sequence number of the data to be received next, and transmits a TCP header including the generated scheduled sequence number (n+8m) and the ACK flag ‘1’ to the first communication apparatus 1 (segment 20). Further, the second communication apparatus 2 discards the segments 15, 17, 19, 21, 23, and 25 transmitted from the first communication apparatus 1 because they have already been sent to the application processor 27, and successively transmits the TCP header including the scheduled sequence number (n+8m) and the ACK flag ‘1’ to the first communication apparatus 1 (segments 22, 24, 26, 28, 30, and 32).

Although the first communication apparatus 1 continuously receives the TCP header including an equal scheduled sequence number (n+8m) and the ACK ‘1’ transmitted from the second communication apparatus 2 (segments 22, 24, and 26) three times, this does not trigger the counting of the equal scheduled sequence number because the scheduled sequence number (n+8m) is not equal to or lower than the sequence numbers that have been updated (n+m to n+8m).

### Third Embodiment

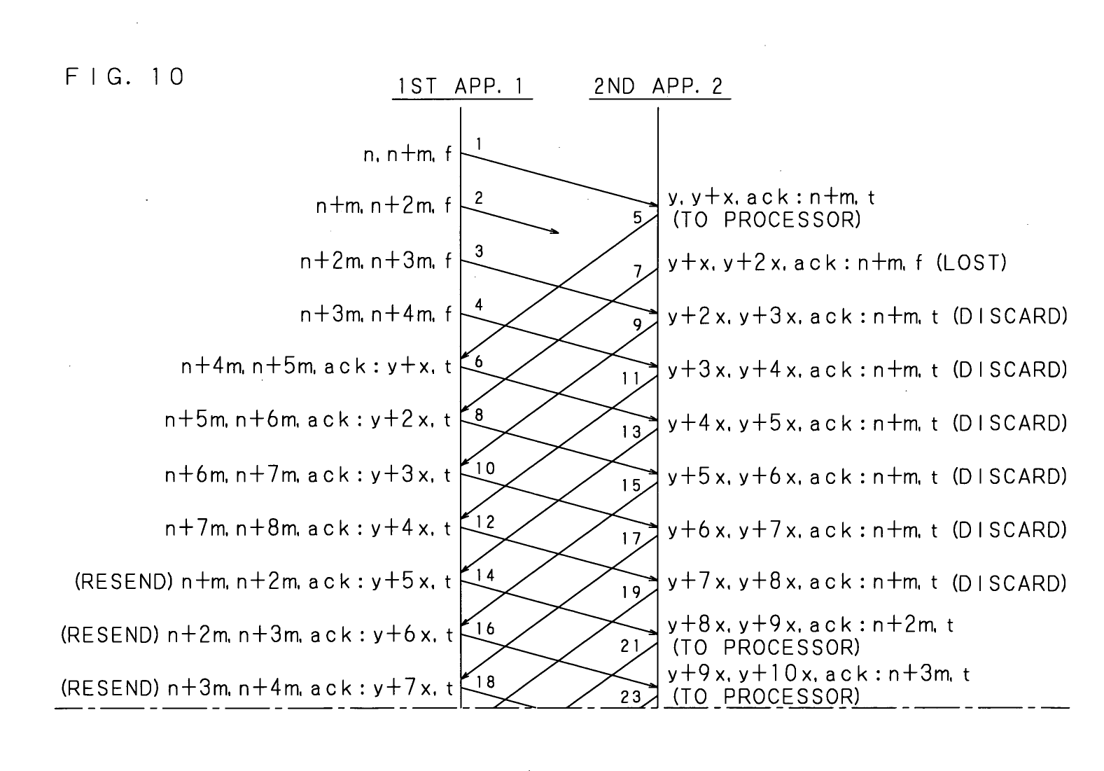

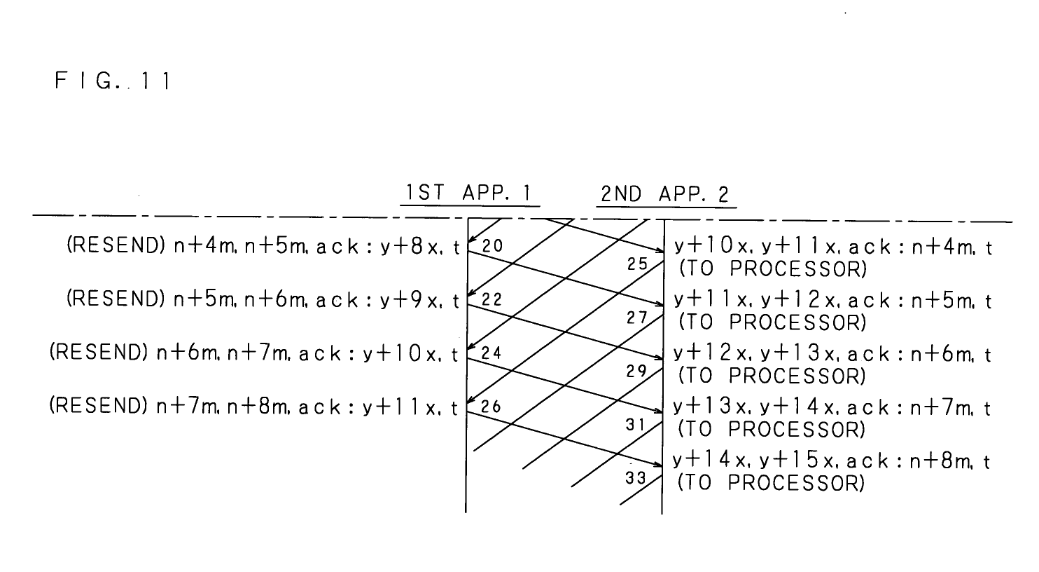

Next, a case where the communication form is “two-way communication” and the second communication apparatus 2 cannot store the successively received segment data into the RAM 23 and discards it will be described as an example. FIGS. 10 and 11 are explanatory views showing an example of the communication sequence controlled in an embodiment.

The first communication apparatus 1 transmits segment data having a sequence number (n) assigned thereto, and updates the sequence number (n) to n+m (segment 1). In the figure, “f” indicates that the CAK flag is ‘0’, that is, data is not received. The same applies hereinafter.

When receiving the data of the segment 1, the second communication apparatus 2 sends the received data of the segment 1 to the application processor 27, generates a scheduled sequence number (n+m), transmits segment data having a sequence number (y) assigned thereto and a TCP header including the generated scheduled sequence number (n+m), the ACK flag ‘1’, and the CAK flag ‘1’ to the first communication apparatus 1, and updates the sequence number (y) to y+x (segment 5). In the figure, “t” indicates that the CAK flag is ‘1’, that is, data is received. The same applies hereinafter.

When the data of the segment 2 transmitted by the first communication apparatus 1 is lost and does not arrive at the second communication apparatus 2, the second communication apparatus 2 cannot receive the data of the segment 2, cannot send the data to the application processor 27, and cannot generate the information corresponding to the scheduled sequence number. Moreover, when transmitting segment data having the sequence number (y+x) assigned thereto, the second communication apparatus 2 transmits a TCP header including the previously generated scheduled sequence number (n+m), the ACK flag ‘1’, and the CAK flag ‘0’ to the first communication apparatus 1, and updates the sequence number (y+x) to y+2x (segment 7).

Moreover, the first communication apparatus 1 transmits segment data having a sequence number (n+2m) assigned thereto and a TCP header including the CAK flag ‘0’ without waiting for the arrival of the ACK flag ‘1’ to be received from the second communication apparatus 2, and updates the sequence number (n+2m) to n+3m (segment 3). Although the second communication apparatus 2 receives the data of the segment 3, it cannot send it to the application processor 27 because the sequence number of the received data of the segment 3 is not equal to the previously generated scheduled sequence number. Moreover, the second communication apparatus 2 discards the segment data because it is in a condition of being unable to store the segment data into the RAM 23. When transmitting segment data having the sequence number (y+2x) assigned thereto, the second communication apparatus 2 transmits a TCK header including the previously generated scheduled segment number (n+m), the ACK flag ‘1’, and the CAK flag ‘1’ to the first communication apparatus 1, and updates the sequence number (y+2x) to y+3x (segment 9).

When receiving the data of the segment 5, the first communication apparatus 1 generates the scheduled sequence number (y+x), transmits segment data having a sequence number (n+4m) assigned thereto and a TCP header including the generated scheduled sequence number (y+x), the ACK flag ‘1’, and the CAK flag ‘1’ to the second communication apparatus 2, and updates the sequence number (n+4m) to n+5m (segment 6). Likewise, the first communication apparatus 1 transmits segment data having the updated sequence number assigned thereto and a TCP header including the generated scheduled sequence number, the ACK flag ‘1’, and the CAK flag ‘1’ to the second communication apparatus 2 (segments 8, 10, and 12).

When transmitting the segment data having the updated sequence number assigned thereto while discarding the received data of the segments 6, 8, 10, etc., the second communication apparatus 2 transmits a TCP header including the previously received scheduled sequence number (n+m), the ACK flag ‘1’, and the CAK flag ‘1’ to the first communication apparatus 1 (segments 13, 15, 17, etc.).

When continuously receiving an equal scheduled sequence number (n+m), the ACK flag ‘1’, and the CAK flag ‘1’ (segments 9, 11, and 13) three times after receiving the data of the segment 5, the first communication apparatus 1 successively transmits segment data having the scheduled sequence number (n+m) and a succeeding sequence number assigned thereto and a TCP header including the scheduled sequence number generated every transmission, the ACK flag ‘1’, and the CAK flag ‘1’ (segments 14, 16, 18, 20, 22, 24, and 26).

The second communication apparatus 2 successively receives the data of the segments 14, 16, 18, 20, 22, 24, and 26 having the scheduled sequence number (n+m) and a succeeding sequence number assigned thereto, successively sends the received segment data to the application processor 27, generates a scheduled sequence number every reception, and successively transmits segment data having a sequence number assigned thereto and a TCP header including the generated scheduled sequence number, the ACK flag ‘1’, and the CAK flag ‘1’ to the first communication apparatus 1 (segments 21, 23, 25, 27, 29, 31, and 33).

### Fourth Embodiment

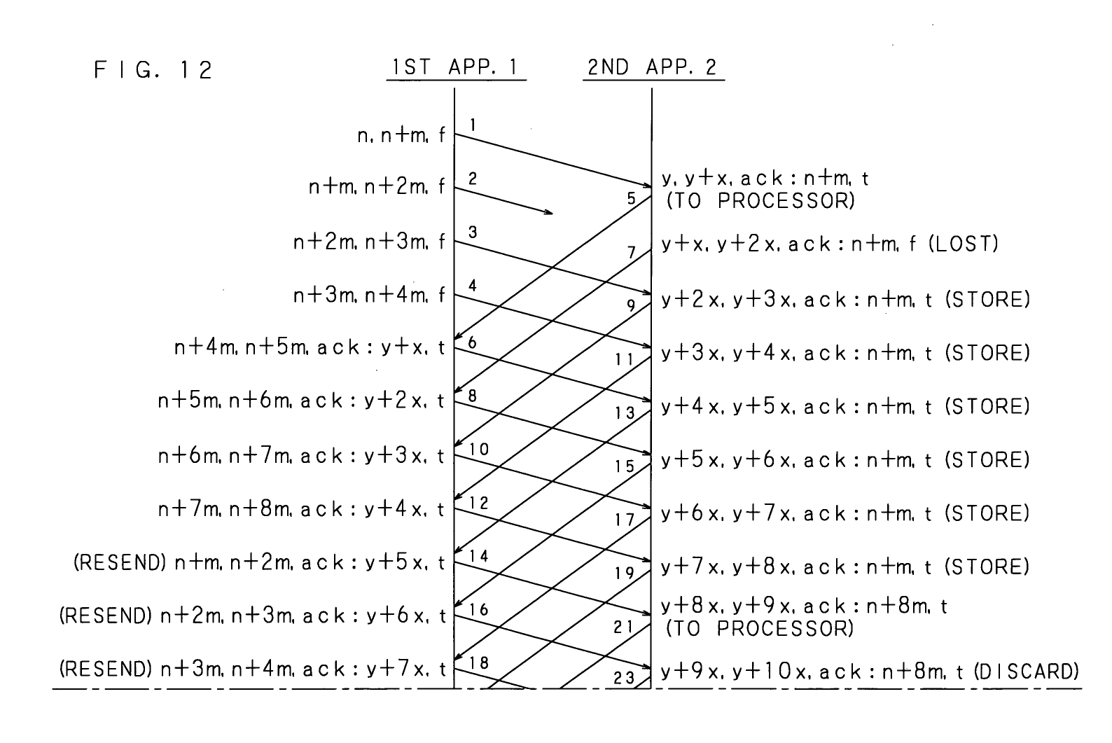

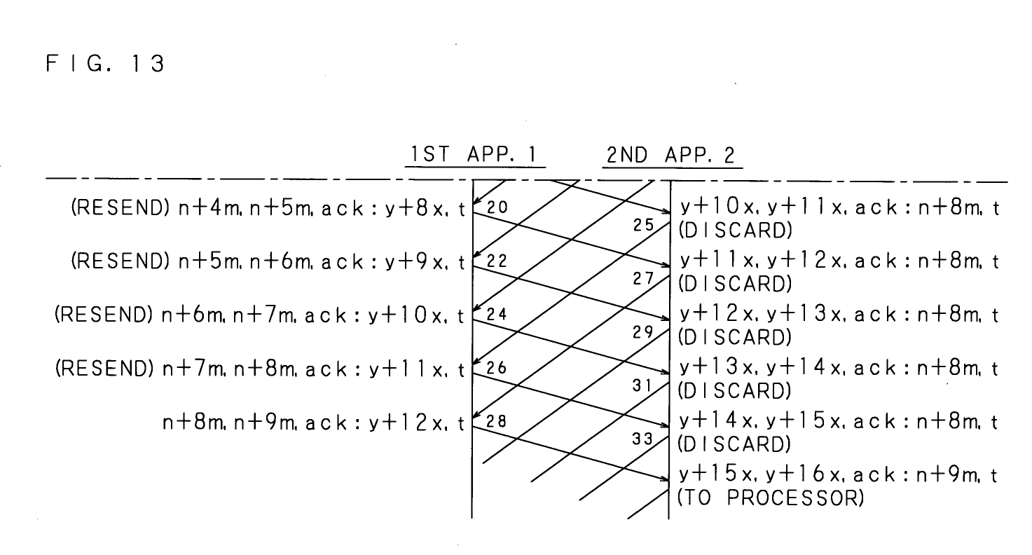

Next, a case where the communication form is “two-way communication” and the second communication apparatus 2 is in a condition of being able to store the successively received segment data into the RAM 23 will be described as an example. FIGS. 12 and 13 are explanatory views showing an example of the communication sequence controlled in an embodiment.

Like the third embodiment, the first communication apparatus 1 stores the window size into the RAM 13, transmits segment data having a sequence number (n) assigned thereto and a TCP header including the CAK flag ‘0’, and updates the sequence number (n) to n+m (segment 1).

When receiving the data of the segment 1, the second communication apparatus 2 sends the received data of the segment 1 to the application processor 27, generates a scheduled sequence number (n+m), transmits segment data having a sequence number (y) assigned thereto and a TCP header including the generated scheduled sequence number (n+m), the ACK flag ‘1’, and the CAK flag ‘1’ to the first communication apparatus 1, and updates the sequence number (y) to y+x (segment 5).

When the data of the segment 2 transmitted by the first communication apparatus 1 is lost and does not arrive at the second communication apparatus 2, the second communication apparatus 2 cannot receive the data of the segment 2, cannot send the data to the application processor 27, and cannot generate a scheduled sequence number. Moreover, when transmitting segment data having the sequence number (y+x) assigned thereto, the second communication apparatus 2 transmits a TCP header including the previously generated scheduled sequence number (n+m), the ACK flag ‘1’, and the CAK flag ‘0’ to the first communication apparatus 1, and updates the sequence number (y+x) to y+2x (segment 7).

Moreover, the first communication apparatus 1 successively transmits segment data having a sequence number assigned thereto and a TCP header including the CAK flag ‘0’ without waiting for the arrival of the ACK flag ‘1’ to be received from the second communication apparatus 2 (segments 3 and 4). Moreover, when receiving the data of the segment 5, the first communication apparatus 1 generates the scheduled sequence number (y+x), transmits segment data having a sequence number (n+4m) assigned thereto and a TCP header including the generated scheduled sequence number (y+x), the ACK flag ‘1’, and the CAK flag ‘1’ to the second communication apparatus 2, and updates the sequence number (n+4m) to n+5m (segment 6). Likewise, the first communication apparatus 1 transmits segment data having the updated sequence number assigned thereto and a TCP header including the generated scheduled sequence number, the ACK flag ‘1’, and the CAK flag ‘1’ to the second communication apparatus 2 (segments 8, 10, and 12).

Since the sequence numbers of the received data of the segments 6, 8, 10, etc. are not equal to the previously generated scheduled sequence number, the second communication apparatus 2 stores the data into the RAM 23, and transmits segment data having the updated sequence number assigned thereto and a TCP header including the previously generated scheduled sequence number (n+m), the ACK flag ‘1’, and the CAK flag ‘1’ to the first communication apparatus 1 (segments 13, 15, 17, etc.).

When continuously receiving an equal scheduled sequence number (n+m), the ACK flag ‘1’, and the CAK flag ‘1’ (segments 9, 11, and 13) three times after receiving the data of the segment 5, the first communication apparatus 1 successively transmits segment data having the scheduled sequence number (n+m) and a succeeding sequence number assigned thereto and a TCP header including the ACK flag ‘1’ and the CAK flag ‘1’ (segments 14, 16, 18, 20, 22, 24, and 26).

When receiving the data of the segment 14 having the sequence number (n+m) assigned thereto, the second communication apparatus 2 reads the data of the segments 3, 4, 6, 8, 10, and 12 stored in the RAM 23, successively sends them to the application processor 27, and sends the data of the segment 14 to the application processor 27. Moreover, the second communication apparatus 2 generates a scheduled sequence number (n+8m), transmits segment data having a sequence number (y+8x) assigned thereto and a TCP header including the generated scheduled sequence number (n+8m), the ACK flag ‘1’, and the CAK flag ‘1’ to the first communication apparatus 1, and updates the sequence number (y+8x) to y+9x (segment 21). Further, the second communication apparatus 2 discards the data of the segments 16, 18, 20, 22, 24, and 26 transmitted from the first communication apparatus 1 because they have already been sent to the application processor 27, and successively transmits segment data having a sequence number assigned thereto and the TCP header including the scheduled sequence number (n+8m), the ACK flag ‘1’, and the CAK flag ‘1’ to the first communication apparatus 1 (segments 23, 25, 27, 29, 31, and 33).

Although the first communication apparatus 1 continuously receives an equal scheduled sequence number (n+8m), the ACK ‘1’, and the CAK flag ‘1’ (segments 23, 25, and 27), this does not trigger the counting of the equal scheduled sequence number because the scheduled sequence number (n+8m) is not equal to or lower than the sequence numbers that have been updated (n+m to n+8m).

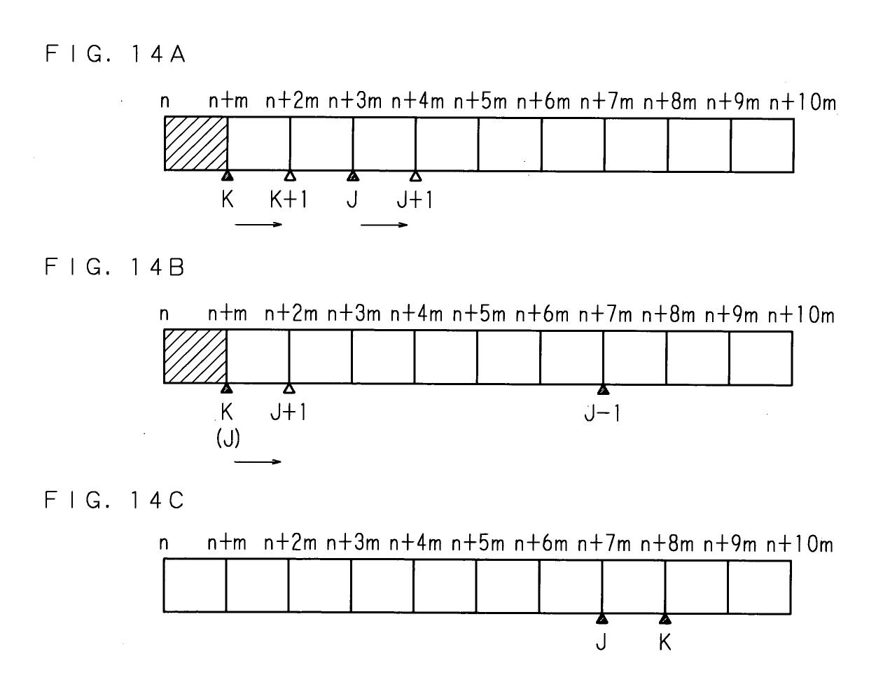

Next, the change of the sequence number and the scheduled sequence number used in an embodiment will be described. FIGS. 14A to 14C are explanatory views showing sequence numbers and scheduled sequence numbers. In the figure, the transmission sequence of the first communication apparatus 1 is denoted by J, and the transmission sequence of the second communication apparatus 2 is denoted by K. The same applies hereinafter.

For example, in the normal data transmission, the first communication apparatus 1 transmits segment data having a sequence number (n+3m) assigned thereto, updates the sequence number (n+3m) to n+4m (segment J), transmits segment data having the sequence number (n+4m) assigned thereto, and updates the sequence number (n+4m) to n+5m (segment J+1). On the other hand, when receiving the segment data transmitted from the first communication apparatus 1, the second communication apparatus 2 generates a scheduled sequence number (n+m), transmits the generated scheduled sequence number (n+m) (segment K), when receiving segment data having an equal sequence number to the scheduled sequence number (n+m) assigned thereto, sends the received segment data to the application processor 27 to render the segment data already received, generates a scheduled sequence number (n+2m), and transmits the generated scheduled sequence number (n+2m). For this, see FIG. 14A.

When the segment data of the sequence number (n+m) transmitted from the first communication apparatus 1 is lost and does not arrive at the second communication apparatus 2, the second communication apparatus 2 cannot generate information corresponding to the scheduled sequence number, and resends the scheduled sequence (n+m) transmitted in the segment K. When continuously receiving an equal scheduled sequence number (n+m) three times, that is, after transmitting segment data having a sequence number (n+7m) assigned thereto (segment J−1), the first communication apparatus 1 returns the sequence number (n+7m) to n+m and transmits segment data having the sequence number (n+m) assigned thereto, updates the sequence number (n+m) to n+2m (segment J), transmits segment data having the sequence number (n+2m) assigned thereto, and updates the sequence number (n+2m) to n+3m (segment J+1). When receiving the segment data having the sequence number (n+m) assigned thereto transmitted from the first communication apparatus 1, the second communication apparatus 2 sends the received segment data to the application processor 27, and treats the segment data as already received. The first communication apparatus 1 has already transmitted the segment data of the sequence numbers (n+m) to (n+8m), and if the data is received without any problem as shown in FIG. 14A, the scheduled sequence numbers to be received from the second communication apparatus 2 are (n+2m) to (n+8m). Therefore, the first communication apparatus 1 determines that the data is lost only when receiving a scheduled sequence number lower than the minimum one (n+2m) of the expected scheduled sequence numbers (expectations of the scheduled sequence numbers) (n+2m) to (n+8m), and starts the counting of the equal scheduled sequence number to perform the above-described processing. For this, see FIG. 14B.

However, in a case where the second communication apparatus 2 generates the scheduled sequence number (n+8m) and transmits the generated scheduled sequence number (n+8m) (segment K) when the first communication apparatus 1 transmits the segment data having the sequence number (n+7m) assigned thereto and updates the sequence number (n+7m) to n+8m (segment J), since the scheduled sequence number (n+8m) is higher than the sequence numbers (n+m to n+8m) having been updated by the first communication apparatus 1 and to be assigned to segment data not having been transmitted yet, the continuously transmitted scheduled sequence number (n+8m) does not indicate that the segment data transmitted from the first communication apparatus 1 is lost on the way and does not arrive at the second communication apparatus 2. Therefore, even when continuously receiving the scheduled sequence number (n+8m) three times, the first communication apparatus 1 does not count it so that it does not trigger data transmission, thereby preventing unnecessary segment data to be transmitted. For this, see FIG. 14C.

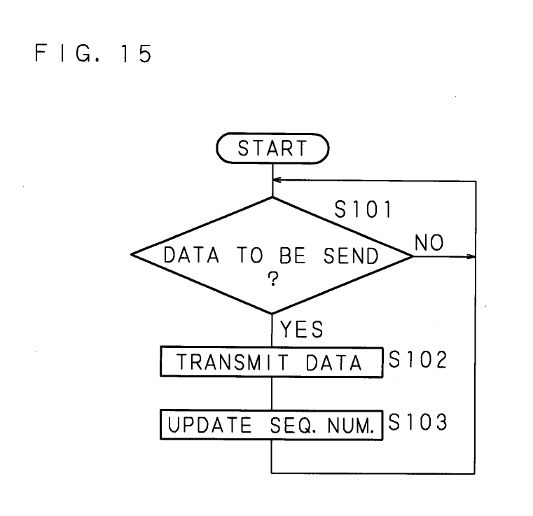

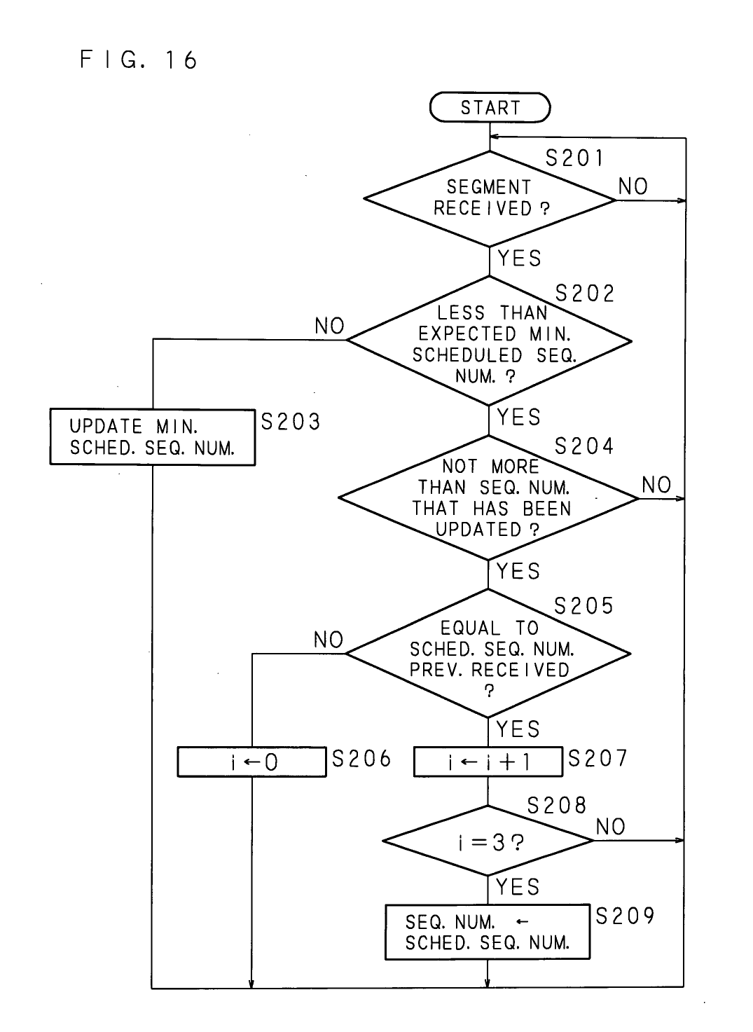

Next, the procedure of the communication processing of the first communication apparatus 1 used in an embodiment will be described. FIG. 15 is a flowchart explaining the procedure of the transmission processing of the first communication apparatus 1. FIG. 16 is a flowchart explaining the procedure of the reception processing of the first communication apparatus 1.

The communication processor 16 of the first communication apparatus 1 determines whether data to be sent is present or not (S101), and when determining that no data to be sent is currently present (NO at S101), the communication processor 16 repeats the determination of step S101 until data to be sent is present.

On the other hand, when data to be sent is currently present (YES at S101), the communication processor 16 assigns a sequence number to the data and transmits it to the second communication apparatus 2 (S102), and updates the sequence number to the next number (S103).

Moreover, the communication processor 16 determines whether a segment including the scheduled sequence number transmitted from the second communication apparatus 2 is received or not (S201), and when determining that the segment is not received (NO at S201), the communication processor 16 repeats the determination of step S201 until the segment is received.

On the other hand, when determining that the segment is received (YES at S201), the communication processor 16 determines whether the scheduled sequence number included in the received segment is less than the expected minimum scheduled sequence number (minimum expectation of the scheduled sequence number) or not (S202), and when determining that the scheduled sequence number is not less than the minimum scheduled sequence number (NO at S202), the communication processor 16 updates the minimum scheduled sequence number to the received scheduled sequence number (S203), and returns to step S201 to be ready for the next reception of the scheduled sequence number.

In receiving the segment 8 by the first apparatus 1, for example in FIG. 8, the minimum expectation of the scheduled sequence number (minimum expected scheduled sequence number) is n+2m. And the first apparatus 1 determines that the received scheduled sequence number, which is n+m, is less than the minimum expectation of the scheduled sequence number.

On the other hand, when determining that the scheduled sequence number is less than the minimum scheduled sequence number (YES at S202), the communication processor 16 determines whether the received scheduled sequence number is not more than the sequence number that has been updated or not (S204), and when determining that the scheduled sequence number is more than the sequence number that has been updated (NO at S204), the communication processor 16 returns to step S201 to be ready for the next reception of the scheduled sequence number.

On the other hand, when determining that the scheduled sequence number is not more than the sequence number that has been updated (YES at S204), the communication processor 16 determines whether the received scheduled sequence number is equal to the previously received scheduled sequence number or not (S205), and when determining that the received scheduled sequence number is not equal to the previously received scheduled sequence number (NO at S205), the communication processor 16 returns a count variable i to 0 (S206), and returns to step S201 to be ready for the next reception of the scheduled number.

On the other hand, when determining that the received scheduled sequence number is equal to the previously received scheduled sequence number (YES at S205), the count variable i is incremented by 1 (S207), and determines whether the count variable i after the increment reaches 3 or not (S208). When determining that the count variable i does not reach 3 or exceeds 3 (NO at S208), the communication processor 16 returns to step S201 to be ready for the next reception of the scheduled sequence number.

In receiving segments 14, 16 and 18, for example in FIGS. 8 and 9, the first apparatus 1 receives the equal scheduled sequence numbers (n+m) three times, and the count variable i has 4, 5 and 6 for the respective receptions. Therefore, the first apparatus 1 determines that upon the receptions of the scheduled sequence numbers in segments 15, 17 and 18 the count variable i exceeds 3 (NO at S208).

On the other hand, when determining that the count variable i reaches 3 (YES at S208), the communication processor 16 updates the sequence number to the continuously received scheduled sequence number (S209), and returns to step S201 to be ready for the next reception of the scheduled sequence number. Moreover, the communication processor 16 performs the transmission processing based on the sequence number updated at step S209 (S101 to S103).

As this invention may be embodied in several forms without departing from the spirit of essential characteristics thereof, the present embodiments are therefore illustrative and not restrictive, since the scope of the invention is defined by the appended claims rather than by description preceding them, and all changes that fall within metes and bounds of the claims, or equivalence of such metes and bounds thereof are therefore intended to be embraced by the claims.

What is claimed is:

1. A communication method for performing data communication between a first apparatus and a second apparatus based on a TCP (Transmission Control Protocol), comprising:
transmitting communication data having a sequence number assigned thereto from the first apparatus to the second apparatus;
updating the sequence number by the first apparatus every transmission;
receiving the communication data transmitted from the first apparatus, by the second apparatus;
generating schedule data corresponding to a scheduled sequence number representing a sequence number of the communication data subsequently to be received, by the second apparatus every reception;
transmitting the schedule data having the scheduled sequence number from the second apparatus to the first apparatus; and
when continuously receiving the schedule data corresponding to an equal scheduled sequence number a plurality of times by the first apparatus, successively transmitting the communication data having the equal scheduled sequence number and the communication data having a succeeding sequence number from the first apparatus to the second apparatus.

2. The communication method according to claim 1, wherein the equal scheduled sequence number precedes the updated sequence number.

3. The communication method according to claim 1, further comprising
storing expectation data of the scheduled sequence number representing the sequence number of the communication data which the first apparatus expects to receive from the second apparatus,
wherein, when the communication data having the equal scheduled sequence number and the communication data having a succeeding sequence number from the first apparatus to the second apparatus are successively transmitted, the scheduled sequence number which the schedule data received by the first apparatus includes is less than the expectation of the scheduled sequence number, and the equal scheduled sequence number precedes the updated sequence number,
wherein the method further comprises
when the scheduled sequence number received by the first apparatus is not less than the expectation data of the scheduled sequence number, updating the expectation data of the scheduled sequence number by the first apparatus as the scheduled sequence number received by the first apparatus.

4. The communication method according to claim 1, further comprising:
transmitting start acknowledgement data as to start of data communication from the first apparatus to the second apparatus;
transmitting start response data to the received start acknowledgement from the second apparatus to the first apparatus; and
when receiving the start response data by the first apparatus, transmitting the communication data from the first apparatus to the second apparatus.

5. A communication method for alternately transmitting a plurality of pieces of data between a first apparatus and a second apparatus based on a TCP, comprising:
transmitting communication data having a sequence number assigned thereto from the first apparatus to the second apparatus;
updating the sequence number by the first apparatus every transmission;
when receiving the communication data transmitted from the first apparatus to the second apparatus, by the second apparatus subsequently to data transmission from the second apparatus to the first apparatus, generating by the second apparatus variable data representing the reception and schedule data corresponding to a scheduled sequence number representing a sequence number of data subsequently to be received;
transmitting the generated variable data and schedule data corresponding to the scheduled sequence number from the second apparatus to the first apparatus; and
when continuously receiving schedule data corresponding to an equal scheduled sequence number together with the variable a plurality of times by the first apparatus, successively transmitting communication data having the equal scheduled sequence number and communication data having a succeeding sequence number from the first apparatus to the second apparatus.

6. The communication method according to claim 5,
wherein the equal scheduled sequence number precedes the updated sequence number.

7. The communication method according to claim 5, further comprising
storing an expectation data of the scheduled sequence number representing the sequence number of data which the first apparatus expects to receive from the second apparatus,
wherein, when the communication data having the equal scheduled sequence number and the communication data having a succeeding sequence number from the first apparatus to the second apparatus are successively transmitted, the scheduled sequence number which the schedule data received by the first apparatus includes is less than the expectation data of the scheduled sequence number, and the equal scheduled sequence number precedes the updated sequence number, and
wherein the method further comprises
when the scheduled sequence number received by the first apparatus is not less than the expectation data of the scheduled sequence number, updating the expectation data of the scheduled sequence number by the first apparatus as the scheduled sequence number received by the first apparatus.

8. The communication method according to claim 5, further comprising:
transmitting start acknowledgement data as to start of data communication from the first apparatus to the second apparatus;
transmitting start response data to the received start acknowledgement from the second apparatus to the first apparatus; and
when receiving the start response data by the first apparatus, transmitting the communication data from the first apparatus to the second apparatus.

9. A communication system provided with a first apparatus and a second apparatus and performing data communication between the apparatuses based on a TCP, the first apparatus including:
an interface successively transmitting communication data having a sequence number assigned thereto; and
a processor updating the sequence number every transmission, and the second apparatus including:
an interface receiving the communication data transmitted from the first apparatus; and
a processor generating schedule data corresponding to a scheduled sequence number representing a sequence number of the communication data subsequently to be received every reception,
wherein the interface of the second apparatus transmits the generated schedule data corresponding to the scheduled sequence number,
wherein the interface of the first apparatus receives the schedule corresponding to the scheduled sequence number transmitted from the second apparatus,
wherein the processor of the first apparatus determines whether or not the received scheduled sequence number is equal to a previously received scheduled sequence number,
wherein the first apparatus further comprises
a counter that counts, when the processor of the first apparatus determines that the received scheduled sequence number is equal, a number of times the schedule data corresponding to the received scheduled sequence number is continuously received,
wherein the processor of the first apparatus determines whether or not a predetermined number of times is reached as a result of the counting, and
wherein, when the processor of the first apparatus determines that the predetermined number of times is reached, the interface of the first apparatus successively transmits communication data having the received scheduled sequence number and a succeeding sequence number to the second apparatus.

10. The communication system according to claim 9,
wherein the processor of the first apparatus:
determines whether the received scheduled sequence number precedes the updated sequence number or not; and
only when a result of the determination is affirmative, determines whether the received scheduled sequence number is equal to the previously received scheduled sequence number or not.

11. The communication method according to claim 9,
wherein the first apparatus further comprises
a storage for storing an expectation of the scheduled sequence number representing the sequence number of data which the first apparatus expects to receive from the second apparatus,
wherein the processor of the first apparatus:
determines whether or not the scheduled sequence number which the schedule received by the first apparatus includes is less than the expectation of the scheduled sequence number;
determines whether or not the scheduled sequence number received by the first apparatus precedes the updated sequence number; and
only when both determination results are affirmative, determines whether or not the received scheduled sequence number is equal to the previously received scheduled sequence number, and
wherein the processor of the first apparatus
when the scheduled sequence number received by the first apparatus is not less than the expectation of the scheduled sequence number, updates the expectation of the scheduled sequence number as the received scheduled sequence number received.

12. The communication system according to claim 9,
wherein the interface of the first apparatus transmits a start acknowledgement as to start of data communication,
wherein the interface of the second apparatus transmits a start response to the received start acknowledgement, and
wherein the interface of the first apparatus transmits the data when receiving the start response.

13. A communication system provided with a first apparatus and a second apparatus and alternately transmitting a plurality of pieces of communication data between the apparatuses based on a TCP, the first apparatus including:
an interface successively transmitting communication data having a sequence number assigned thereto; and
a processor updating the sequence number every transmission, and the second apparatus including:
a processor determining, when the second apparatus transmits the communication data, whether or not data to be received is received by the second apparatus from the first apparatus,
wherein when the processor of the second apparatus determines that the communication data to be received is received by the second apparatus, the processor of the second apparatus generates a variable representing that the communication data to be received is received by the second apparatus and schedule data corresponding to a scheduled sequence number representing a sequence number of the communication data subsequently to be received,
wherein the second apparatus further comprises
an interface transmitting the generated variable and schedule data corresponding to the scheduled sequence number,
wherein the interface of the first apparatus receives the variable and the schedule data having the scheduled sequence number transmitted from the second apparatus,
wherein the processor of the first apparatus determines whether or not the received scheduled sequence number is equal to a previously received scheduled sequence number,
wherein the first apparatus further comprises
a counter counting, when the processor of the first apparatus determines that the received scheduled sequence number is equal, a number of times the variable and the schedule data corresponding to the received scheduled sequence number are continuously received,
wherein the processor of the first apparatus determines whether or not a predetermined number of times is reached as a result of the counting, and
wherein when the processor of the first apparatus determines that the predetermined number of times is reached, the interface of the first apparatus successively transmits the communication data having the received scheduled sequence number and a succeeding sequence number to the second apparatus.

14. The communication system according to claim 13, wherein the processor of the first apparatus:
determines whether the received scheduled sequence number precedes the updated sequence number or not; and
only when a result of the determination is affirmative, determines whether the received scheduled sequence number is equal to the previously received scheduled sequence number or not.

15. The communication method according to claim 13,
wherein the first apparatus further comprises
a storage for storing an expectation of the scheduled sequence number representing the sequence number of communication data which the first apparatus expects to receive from the second apparatus,
wherein the processor of the first apparatus:
determines whether or not the scheduled sequence number which the schedule data received by the first apparatus includes is less than the expectation of the scheduled sequence number;
determines whether or not the scheduled sequence number received by the first apparatus precedes the updated sequence number; and
only when both determination results are affirmative, determines whether or not the received scheduled sequence number is equal to the previously received scheduled sequence number, and
wherein the processor of the first apparatus
when the scheduled sequence number received by the first apparatus is not less than the expectation of the scheduled sequence number, updates the expectation of the scheduled sequence number as the received scheduled sequence number received.

16. The communication system according to claim 13,
wherein the interface of the first apparatus transmits start acknowledgement data as to start of data communication,
wherein the interface of the second apparatus transmits start response data to the received start acknowledgement, and
wherein the interface of the first apparatus transmits the communication data when receiving the start response.

17. A communication apparatus capable of data communication with an outside based on a TCP, comprising:
an interface successively transmitting data having a sequence number assigned thereto; and
a processor updating the sequence number every transmission,
wherein the interface receives schedule data corresponding to a scheduled sequence number transmitted from an external apparatus,
wherein the processor:
determines whether the received scheduled sequence number precedes the updated sequence number or not; and
when a result of the determination is affirmative, determines whether the received scheduled sequence number is equal to the previously received scheduled sequence number or not,
wherein the communication apparatus further comprises
a counter counting, when the processor determines that the received scheduled sequence number is equal, a number of times the schedule data corresponding to the received scheduled sequence number is continuously received, and
wherein when a predetermined number of times is reached as a result of the counting, the interface successively transmits communication data having the received scheduled sequence number and a succeeding sequence number to the external apparatus.

18. A computer readable storage medium storing a computer executable computer program for causing a computer to perform data communication with an outside based on a TCP, the computer program comprising:
causing the computer to update a sequence number assigned to data every time the data is transmitted;
causing the computer to determine whether a scheduled sequence number received from the external apparatus precedes the updated sequence number or not;
causing the computer to determine whether the received scheduled sequence number is equal to a previously received scheduled sequence number or not when a result of the determination is affirmative;
causing the computer to count a number of times information corresponding to the received scheduled sequence number is continuously received when the computer determines that the received scheduled sequence number is equal; and
causing the computer to transmit communication data having the received scheduled sequence number and a succeeding sequence number when a predetermined number of times is reached as a result of the counting.
